(19) United States
(12) Patent Application Publication
(10) Pub. No.: US 2014/0009871 A1
(43) Pub. Date: Jan. 9, 2014

(54) ELECTRICAL DISTRIBUTION SYSTEM AND METHOD

(71) Applicant: Rickey George Bailey, Birmingham, AL (US)

(72) Inventor: Rickey George Bailey, Birmingham, AL (US)

(21) Appl. No.: 13/914,681

(22) Filed: Jun. 11, 2013

Related U.S. Application Data
(60) Provisional application No. 61/668,901, filed on Jul. 6, 2012.

(51) Int. Cl. H02B 1/48

(52) U.S. Cl. CPC H02B 1/48
USPC 361/625

(57) ABSTRACT

Electrical distribution systems and methods are disclosed. An example electrical distribution system includes one or more splitter connectors, each allowing one power source to be split into two or more power sources; one or more joining connectors, each allowing connection between a power source wire and a plurality of light or ceiling fan wires using only one connector; and one or more distribution units, each configured to distribute power to at least one light circuit and/or wall outlets using only one power source from a main power supply or breaker box.

### PRIORITY CLAIM

This application claims the benefit of U.S. Provisional Patent Application No. 61/668,901 titled “Electrical Distribution Systems and Methods” of Rickey George Bailey, filed on Jul. 6, 2012, and incorporated by reference as though fully set forth herein.

### BACKGROUND

Most houses, buildings and other living spaces today have electrical power. However, the wiring installed at the time the house or building was originally constructed may not provide the desired layout. For example, outlets may not be provided in the desired locations, or more outlets may be needed. This is often the case in modular homes and older buildings, but can be a problem in any house or other building.

Frequently, in order to construct a desired layout, many wires need to be run from the breaker box just to provide power to a single room. Because electrical wiring can take a long time (e.g., making connections with wire nuts), and can be difficult to understand, improper wiring (e.g., loose connections, or misconnections such as connecting a “hot” to a “neutral” or “ground”) can increase the risk of fire, electrocution, or other safety hazard. Thus, adding electric wires is typically a difficult and highly specialized task, often requiring the services of a licensed electrician.

### BRIEF DESCRIPTION OF THE DRAWINGS

FIG. 1 illustrates an isometric view of an example electrical distribution system housing.

FIG. 2 illustrates a rear view of the example distribution system housing shown in FIG. 1.

FIG. 3 illustrates a front view of the example distribution system housing shown in FIG. 1.

FIG. 4 illustrates a side view of the example distribution system housing shown in FIG. 1.

FIG. 5 illustrates an isometric view of an example distribution system housing shown in a partially open configuration.

FIG. 6 illustrates an isometric view of an example splitter connector.

FIG. 7 illustrates an rear view of the example splitter connector shown in FIG. 6.

FIG. 8 illustrates a front view of the example splitter connector shown in FIG. 6.

FIG. 9 illustrates a side view of the example splitter connector shown in FIG. 6.

FIGS. 10A-C illustrate top views of example conductive plates of an example splitter connector.

FIG. 11 illustrates an isometric view of an example switch connector.

FIG. 12 illustrates a front view of the example switch connector shown in FIG. 12.

FIG. 13 illustrates a rear view of the example switch connector shown in FIG. 12.

FIG. 14 illustrates a side view of the example switch connector shown in FIG. 12.

FIGS. 15A-C illustrate top views of example conductive plates of an example switch connector.

FIG. 16 illustrates an isometric view of an example end connector.

FIG. 17 illustrates a front view of the example end connector shown in FIG. 16.

FIG. 18 illustrates a top view of the example end connector shown in FIG. 16.

FIG. 19 illustrates a side view of the example end connector shown in FIG. 16.

FIG. 20 illustrates a first isometric view of an example end connector shown in an open configuration.

FIG. 21 illustrates a second isometric view of the example end connector shown in an open configuration.

FIG. 22 illustrates a top view of an example mini electrical distribution system.

FIG. 23 illustrates an isometric view of the example mini electrical distribution system shown in FIG. 22.

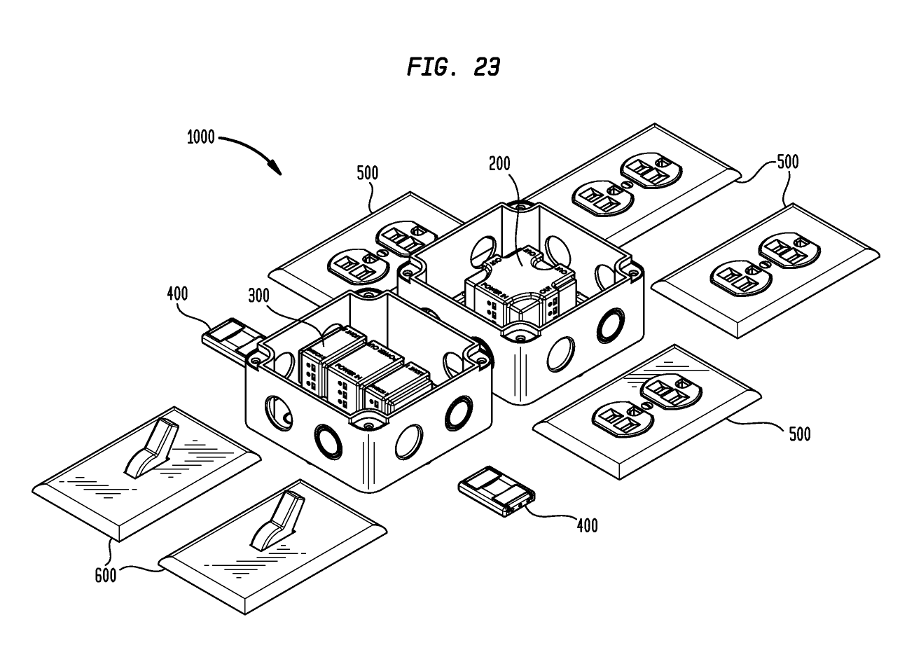

FIG. 24 illustrates a top view of an example main electrical distribution system.

FIG. 25 illustrates an isometric view of the example main electrical distribution system shown in FIG. 24.

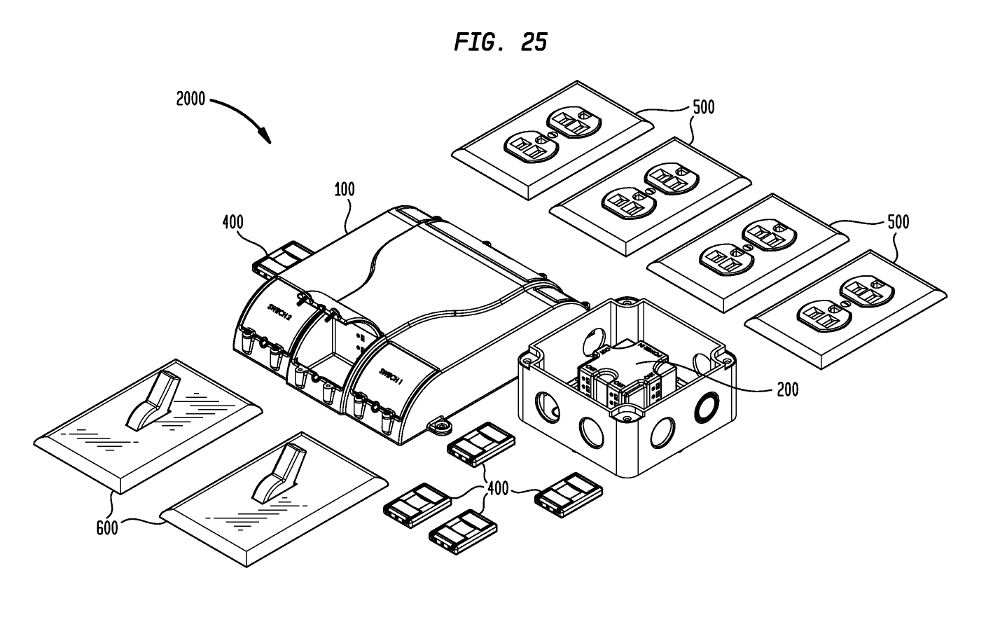

### DETAILED DESCRIPTION

Electrical distribution systems and methods are disclosed which include modular components which enable simpler, and faster electrical wiring connection via components that are easy to understand and do not necessitate the use of wire nuts or electrical tape. The modular components (or “modules”—hence the modularity of this system) are interchangeable with other of the same modules, and any number and/or type of the individual modules may be used to provide and/or change configuration of any desired electrical distribution system. The modular components may also be marketed or sold as a “kit” wherein a basic kit may include some modules and can be readily expanded by purchasing additional modules that work with the modules of the basic kit. With the disclosed systems and methods, fewer wires have to be run back to the power source (e.g., the electric breaker box), and a user is less likely to misconnect wires. Other and/or additional benefits may also be realized.

An example electrical distribution system includes one or more splitter connectors 200, each enabling a power source to be split into two or more power sources. One or more distribution units 300 may each be configured to distribute power to at least one lighting circuit and/or wall outlet(s) using a power source from a main power supply or breaker box. One or more joining connectors 400 may each enable connection between a power source wire and a plurality of light or ceiling fan connections (or other load).

An example method of providing an electrical distribution system includes providing one or more splitter connectors 200, each allowing a power source to be split into two or more power sources. The method may also include providing one or more joining connectors 400, each allowing connection between a power source wire and a plurality of light or ceiling fan wires. The method may also include providing one or more distribution units 300, each configured to distribute power to at least one light circuit and/or wall outlets (or other load) using a power source (e.g., from a main power supply or breaker box).

It is noted that each component described herein may be used individually or together with one or more other of the components described herein (and/or with one or more conventional electrical components and/or systems). In addition, each component may include the connections shown and described herein, more, fewer, and/or different connections. For example, a component may include one or more outlet connection and/or one or more switching connection and/or one or more other electrical connection.

Before continuing, it is noted that as used herein, the terms “includes” and “including” mean, but is not limited to, “includes” or “including” and “includes at least” or “including at least.” The term “based on” means “based on” and “based at least in part on.”

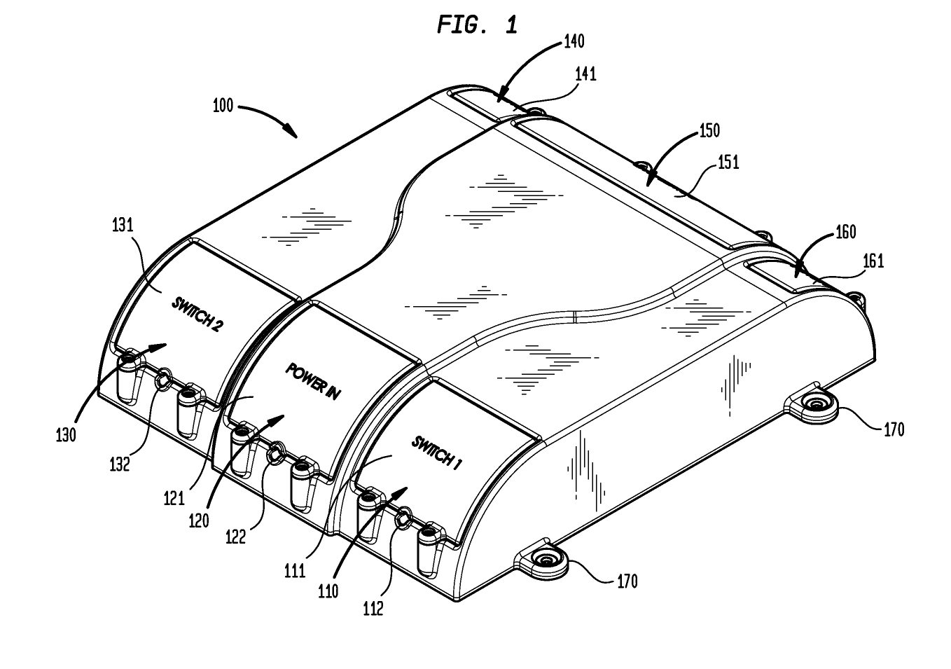

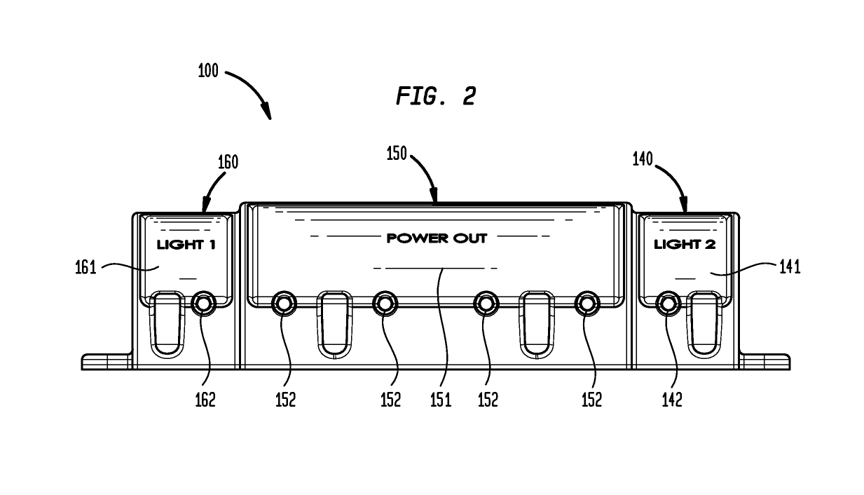

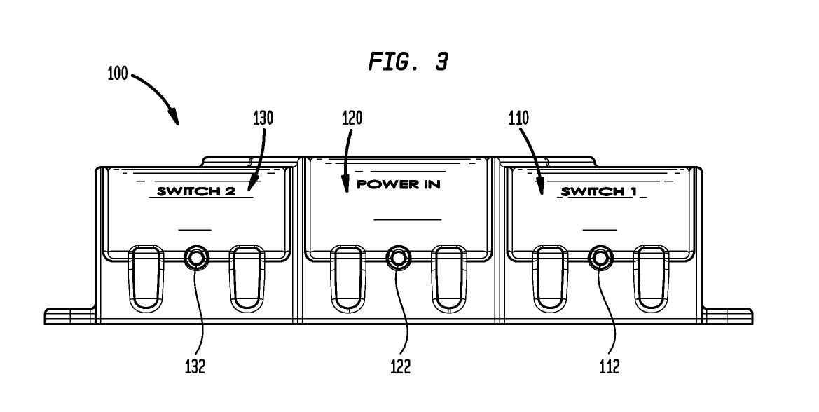

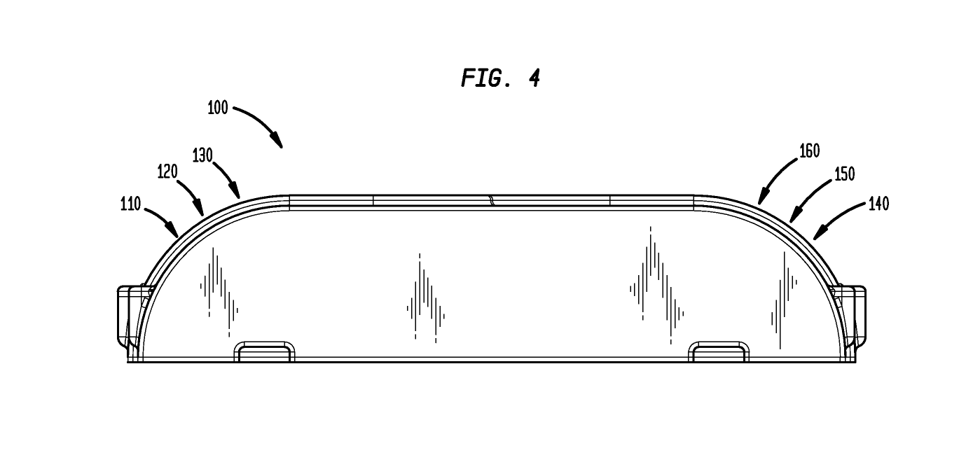

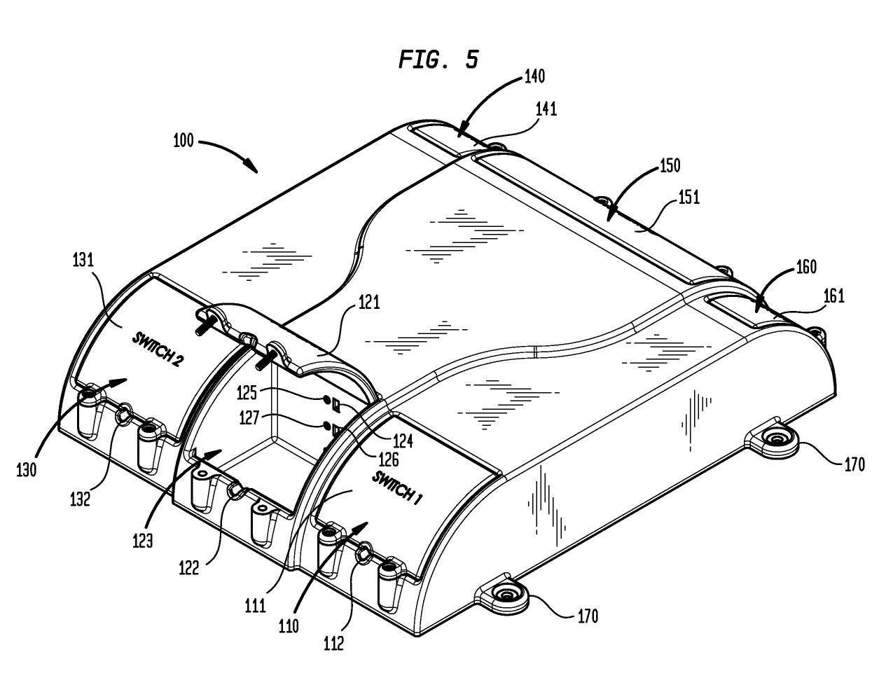

FIG. 1 illustrates an isometric view of an example electrical distribution system housing. The example system for distributing electrical power from a main power supply or breaker box, is illustrated as it may include a distributer housing 100, one or more splitter connectors 200, one or more switch connectors 300 and one or more joining connectors 400. FIG. 2 illustrates a rear view of the example distribution system housing shown in FIG. 1. FIG. 3 illustrates a front view of the example distribution system housing shown in FIG. 1. FIG. 4 illustrates a side view of the example distribution system housing shown in FIG. 1. FIG. 5 illustrates an isometric view of an example distribution system housing shown in a partially open configuration.

The distributor housing 100 (e.g., the “main box”) includes a switch inlet 110, a power inlet 120, a light circuit outlet 160, and a power or wall socket outlet 150. The power inlet 120 is illustrated as it may include a pivotable panel 121 for selectively enclosing a power inlet space 123 configured to receive and protect an end portion of a compound electrical wire. Power terminal 125, neutral terminal 127 and ground terminal 129 may be provided to receive power, neutral, and ground connections from a compound electrical wire.

Actuators 124, 126 and 128 enable a user to quickly secure the end portions of power, neutral and ground components of the compound electrical wire into, and to release the end portions from conductive contact with the power 125, neutral 127 and ground 129 terminals, respectively. An opening 122 may be provided to accommodate the external diameter of a compound electrical wire extending into the power inlet space 123.

Switch inlet 110 is shown as it may include a pivotable panel 111 for selectively enclosing a switch inlet space, configured to receive and protect an end portion of a compound electrical wire. Power 115, neutral 117 and ground 119 terminals are provided to receive power, neutral and ground components of a compound electrical wire, respectively.

Actuators 114, 116 and 118 enable a user to quickly secure the end portions of power, neutral and ground components of the compound electrical wire into and release the end portions from conductive contact with the power 115, neutral 117 and ground 119 terminals, respectively. A small opening 112 accommodates the external diameter of a compound electrical wire extending into the switch inlet space.

In an example, one or more additional switch inlets 130 having each having a panel 131, terminals 135, 137 and 139 as well as actuators 134, 136 and 138 and opening 132 may be provided.

Power outlet 150 is shown as it may include a pivotable panel 151 for selectively enclosing a power outlet space configured to receive and protect an end portion of a compound electrical wire. Power 155, neutral 157 and ground 159 terminals are provided to receive power, neutral and ground components of a compound electrical wire, respectively.

Actuators 154, 156 and 158 enable a user to quickly secure the end portions of power, neutral and ground components of the compound electrical wire into and release the end portions from conductive contact with the power 155, neutral 157 and ground 159 terminals, respectively. A small opening 152 accommodates the external diameter of a compound electrical wire extending into the power outlet space. A plurality of power terminals 155, a plurality of neutral terminals 157, a plurality of ground terminals 159 as well as a plurality of actuators 154, a plurality of actuators 156, a plurality of actuators 158 and a plurality of openings 152 may be provided when multiple outflows are provided to outlet 150.

Light circuit outlet 160 is shown as it may include a pivotable panel 161 for selectively enclosing a light circuit outlet space configured to receive and protect an end portion of a compound electrical wire. Power 165, neutral 167 and ground 169 terminals are provided to receive power, neutral and ground components of a compound electrical wire, respectively.

Actuators 164, 166 and 168 enable a user to quickly secure the end portions of power, neutral and ground components of the compound electrical wire into and release the end portions from conductive contact with the power 165, neutral 167 and ground 169 terminals, respectively. A small opening 162 accommodates the external diameter of a compound electrical wire extending into the light circuit outlet space.

In an example, one or more additional light circuit outlets 140 having each having a panel 141, terminals 145, 147 and 149 as well as actuators 144, 146 and 148 and opening 142 may be provided.

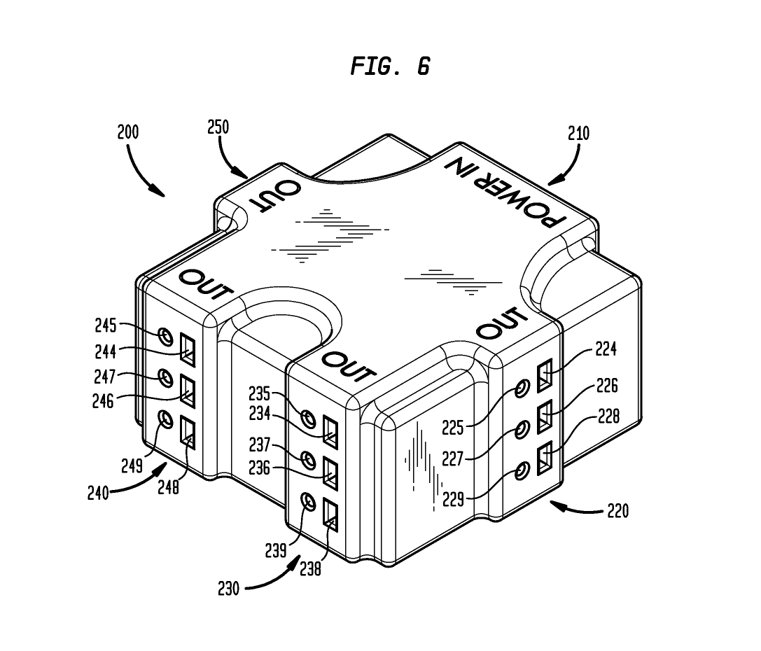

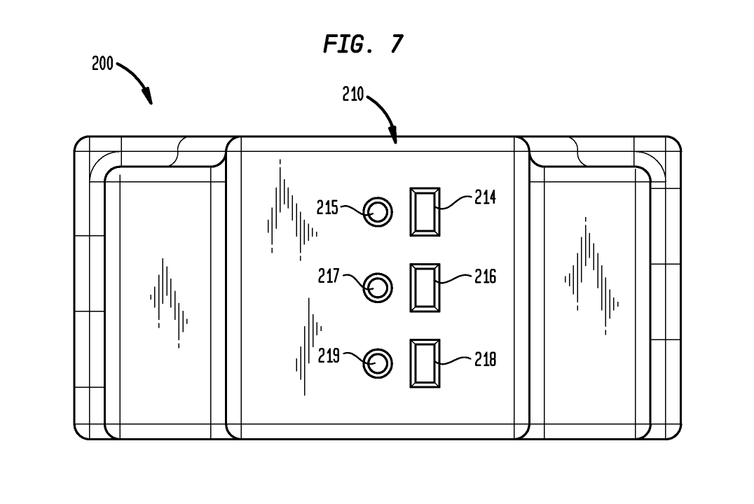

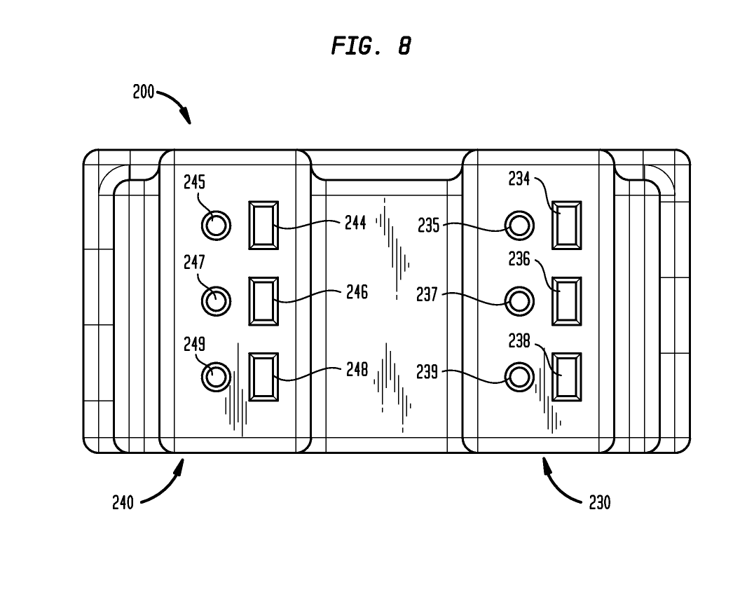

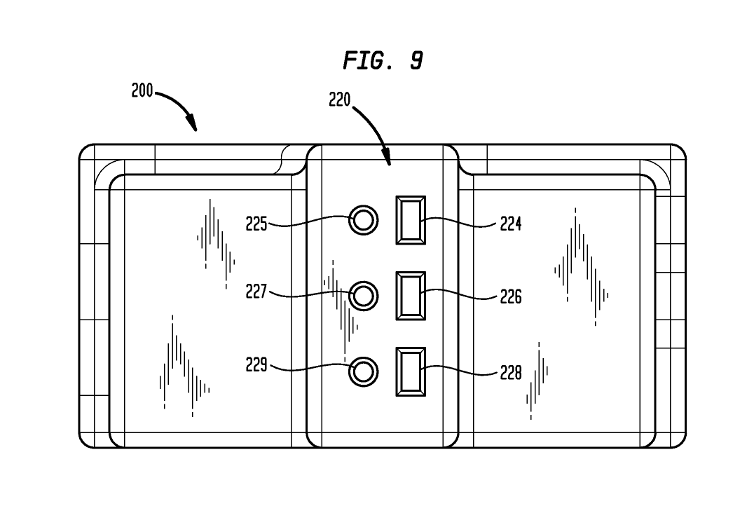

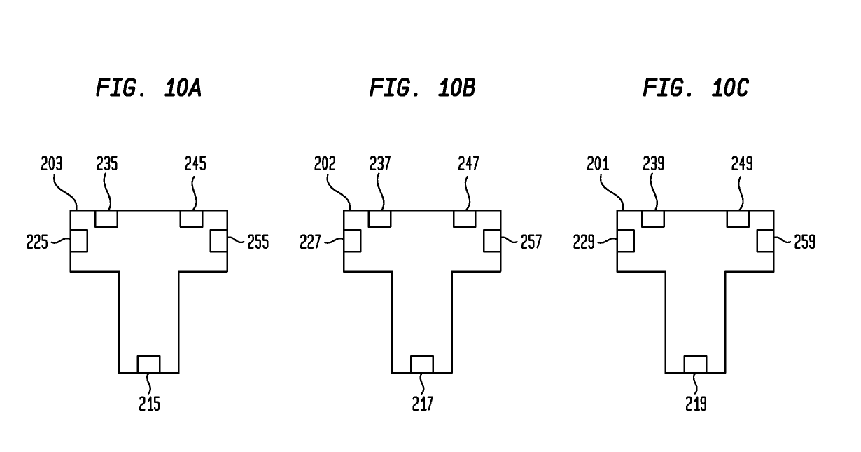

At least one connector may be provided for splitting one power source into two or more power sources. FIG. 6 illustrates an isometric view of an example splitter connector. FIG. 7 illustrates an rear view of the example splitter connector shown in FIG. 6. FIG. 8 illustrates a front view of the example splitter connector shown in FIG. 6. FIG. 9 illustrates a side view of the example splitter connector shown in FIG. 6. FIGS. 10A-C illustrate top views of example conductive plates of an example splitter connector.

The splitter connector 200 is shown as it may include a splitter power inlet 210 and two or more splitter power outlets 220, 230, 240 and 250 configured for operative coupling with light circuit outlets 140 and/or 160 and the wall socket outlets or power outlets 150.

Splitter connector 200 may also include ground 201, neutral 202 and power 203 conducting plates (as best seen in FIGS. 10A-C), each having a power input terminal and power output terminals. In an example, the ground plate 201 includes a power input ground wire terminal 219 and power output ground wire terminals 229, 239, 249 and 255. Neutral plate 202 conducts electricity between a power input neutral wire terminal 217 and power output neutral wire terminals 227, 237, 247 and 257. Power plate 203 conducts electricity between a power input power wire terminal 215 and power output power wire terminals 225, 235, 245 and 255. It is noted that the plates 201, 202 and 203 may be formed from any of a variety of conductive materials. For example, plates 201, 202 and 203 may be formed from copper.

Splitter connector 200 includes an insulating region between the ground 201 and neutral 202 plates, and an insulating region between the neutral 202 and power 203 plates such that the plates and insulating regions alternate in a stacked construction. In an example, the ground 201, neutral 202 and power 203 plates may be provided with more or less than the four outlets 220, 230, 240 and 250 depicted in FIGS. 10A-C.

The splitter power inlet 210 s shown as it may include power 215, neutral 217 and ground 219 terminals provided to receive power, neutral and ground components of a compound electrical wire, respectively. Actuators 214, 216 and 218 may be provided to enable a user to quickly secure the end portions of power, neutral and ground components of the compound electrical wire into and release the end portions from conductive contact with the power 215, neutral 217 and ground 219 terminals, respectively.

Similarly, actuators 224, 226 and 228 may be provided to enable a user to quickly secure the end portions of power, neutral and ground components of the compound electrical wire into, and to release the end portions from conductive contact with the power 225, neutral 227 and ground 229 terminals, respectively. Actuators 234, 236 and 238 may be provided to enable a user to quickly secure the end portions of power, neutral and ground components of the compound electrical wire into and release the end portions from conductive contact with the power 235, neutral 237 and ground 239 terminals, respectively. The actuators 244, 246 and 248 may be provided to enable a user to quickly secure the end portions of power, neutral and ground components of the compound electrical wire into and release the end portions from conductive contact with the power 245, neutral 247 and ground 249 terminals, respectively. The actuators 254, 256 and 258 may be provided to enable a user to quickly secure the end portions of power, neutral and ground components of the compound electrical wire into and release the end portions from conductive contact with the power 255, neutral 257 and ground 259 terminals, respectively.

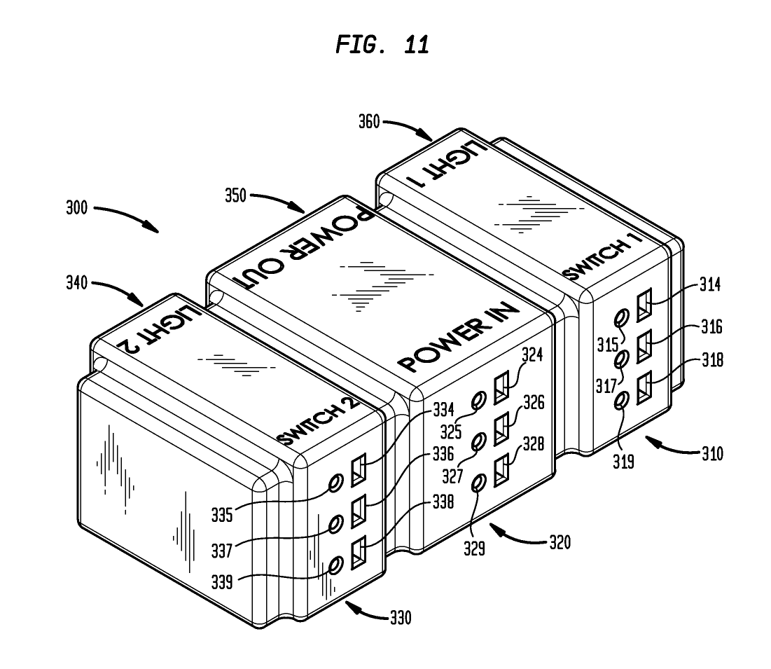

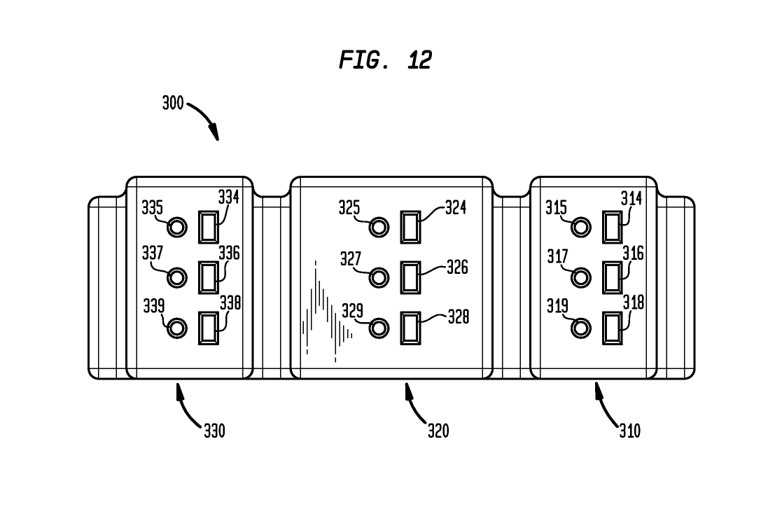

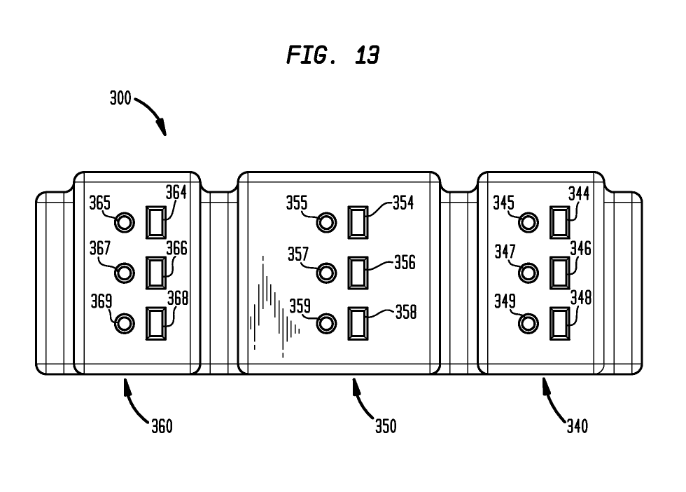

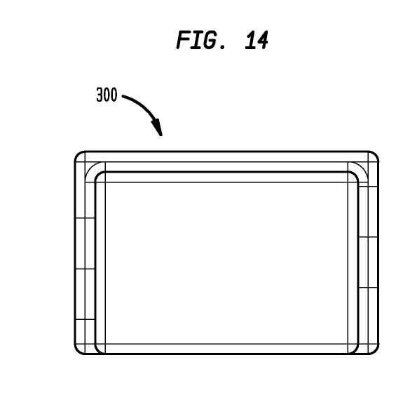

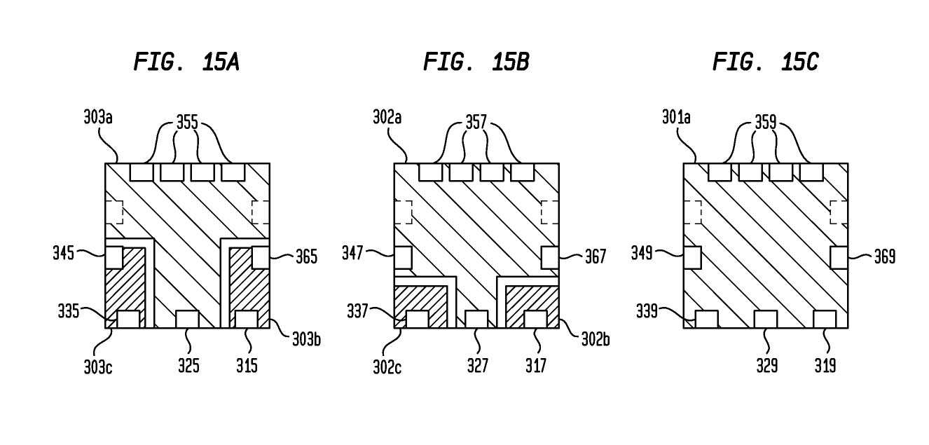

FIG. 11 illustrates an isometric view of an example switch connector. FIG. 12 illustrates a front view of the example switch connector shown in FIG. 12. FIG. 13 illustrates a rear view of the example switch connector shown in FIG. 12. FIG. 14 illustrates a side view of the example switch connector shown in FIG. 12. FIGS. 15A-C illustrate top views of example conductive plates of an example switch connector.

In the example illustrated, a switch connector 300 includes at least one power inlet 320 having power 325, neutral 327 and ground 329 terminals configured for operative coupling with terminals 125, 127 and 129 of distributor housing power inlet 120, respectively. Power 315, neutral 317 and ground 319 terminals of a switch inlet 310 are configured for operative coupling with power 115, neutral 117 and ground 119 terminals of distributor housing switch inlet 110, respectively. Power 355, neutral 357 and ground 359 terminals of power outlet 350 are configured for operative coupling with, for example, power 215, neutral 217 and ground 219 terminals of splitter power inlet 210, respectively.

Power 365, neutral 367 and ground 369 terminals of light circuit outlet 360 are configured for operative coupling with, power 165, neutral 167 and ground 169 terminals of distributor housing light circuit outlet 160, respectively.

In an example, the switch connector 300 includes two or more switch inlets. For example, switch connector 300 may include a second switch inlet 330 having ground 339, neutral 337 and power 335 terminals configured for operative coupling with ground 139, neutral 137 and power 135 terminals of second distributor housing switch inlet 130, respectively.

In an example, switch connector 300 includes two or more light circuit outlets. For example, switch connector 300 may include a second light circuit outlet 340 having ground 349, neutral 347 and power 345 terminals configured for operative coupling with ground 149, neutral 147 and power 145 terminals of second distributor housing light circuit outlet 140, respectively.

Switch connector 300 includes a ground plate 301a, first and second neutral plates 302a-b; and first and second power plates 303a-b. In another example, more than two neutral plates and more than two power plates may be provided. For example, a third neutral plate 302c and a third power plate 303c may be provided.

Ground plate 301a is shown as it may include a power input terminal 329, switch input terminal 319, light circuit output terminal 369, and power output terminals 359. Thus, ground plate 301a connects the at least one switch connector input terminal 319, the at least one switch connector power input terminal 329, switch connector power output terminals 359 and switch connector light circuit output terminal 369. In switch connector examples including a second switch inlet 330, ground plate 301a may include a second switch input terminal 339. Similarly, in switch connector examples including a second light circuit outlet 340, ground plate 301a may include a second circuit output terminal 349.

First neutral plate 302a is shown as it may include a power input terminal 327, a light circuit output terminal 367 and power output terminals 357. Thus, the first neutral plate conducts electricity between switch connector power input terminal 327, switch connector light circuit output terminal 367, and switch connector power output terminals 357. In switch connector examples including a second light circuit outlet 340, first neutral plate 302a may include a second circuit output terminal 347.

Second neutral plate 302b is shown as it may include a switch input terminal 317, and is operatively coupled with second power plate 303b . Second neutral plate 302b conducts electricity between switch connector input terminal 317 and second power plate 303b.

In switch connector examples including a second switch inlet 330 and a second light circuit outlet 340, a third neutral plate 302c may be provided which includes a second switch input terminal 337 and is operatively coupled with third power plate 303c such that electricity may be conducted therebetween.

First power plate 303a is shown as it may include a power input terminal 325 and two or more power output terminals 355. In this configuration, first power plate 303a conducts electricity between the switch connector power input terminal 325 and the switch connector power output terminals 355.

Second power plate 303b is shown as it may include a switch input terminal 315 and a light circuit output terminal 365.

In switch connector examples including a second switch inlet 330 and a second light circuit outlet 340, a third power plate 303c may be provided which includes a second switch input terminal 335 and a second light circuit output terminal 345 such that electricity may be conducted therebetween.

The switch connector 300 is shown as it may include at least one insulating region between the ground 301 and neutral plates 302 and one insulating region between the neutral 302 and power 303 plates, such that the plates and insulating regions alternate in a stacked construction. Further, an insulating region may be provided between first neutral plate 302a and second neutral plate 302b and an insulating region may be provided between first power plate 303a and second power plate 303b.

In an example, second power plate 303b and second neutral plate 302b may be integral and formed of a single plate shaped such that two planar portions thereof are spaced apart and parallel. For example, a single plate may be formed at about 90 degrees at a first proximal location, and about 90 degrees again at a second, distal location so as to form three sides of a rectangle in profile. However, a single plate configured to serve as both the second power plate 303b and the second neutral plate 302b may take any of a variety of shapes. In examples including a third power plate 303c and third neutral plate 302c, these plates may also be formed as a single piece with parallel, spaced-apart planar portions. A third power plate 303c and a third neutral plate 302c may be similarly formed as a single plate.

Switch power inlet 320 is shown as it may include power 325, neutral 327 and ground 329 terminals are provided to receive power, neutral and ground components of a compound electrical wire, respectively. Actuators 324, 326 and 328 enable a user to quickly secure the end portions of power, neutral and ground components of the compound electrical wire into and release the end portions from conductive contact with the power 325, neutral 327 and ground 329 terminals, respectively. Similarly, actuators 314, 316 and 318 may be provided to enable a user to quickly secure the end portions of power, neutral and ground components of the compound electrical wire into and release the end portions from conductive contact with the power 315, neutral 317 and ground 319 terminals, respectively; actuators 334, 336 and 338 enable a user to quickly secure the end portions of power, neutral and ground components of the compound electrical wire into and release the end portions from conductive contact with the power 335, neutral 337 and ground 339 terminals, respectively.

Actuators 344, 346 and 348 may be provided to enable a user to quickly secure the end portions of power, neutral and ground components of the compound electrical wire into and release the end portions from conductive contact with the power 345, neutral 347 and ground 349 terminals, respectively. Actuators 354, 356 and 358 may be provided to enable a user to quickly secure the end portions of power, neutral and ground components of the compound electrical wire into and release the end portions from conductive contact with the power 355, neutral 357 and ground 359 terminals, respectively. Actuators 364, 366 and 368 may be provided to enable a user to quickly secure the end portions of power, neutral and ground components of the compound electrical wire into and release the end portions from conductive contact with the power 365, neutral 367 and ground 369 terminals, respectively.

In an example, at least one splitter connector 200 and at least one switch connector 300 are configured to be encompassed by a central enclosure of the distributor housing 100.

To provide input power to power inlet 120 from a power source or breaker box, panel 121 may be pivoted into an open position (shown by way of example in FIG. 5) and exposed ends of the power, neutral and ground components wires may be inserted into terminals 125, 127 and 129, respectively, with actuators 124, 126 and 128 in a receiving state. After component wires have been received, actuators 124, 126 and 128 are positioned into their securing state, the compound electrical wire is placed within opening 122 and panel 121 is pivoted back to its closed position. Panel 121 may be secured in the closed position with one or more fasteners such as, for example, screws.

Connections may be made to switch inlet 110, power outlet 150 and light circuit outlet 160 in a process analogous to the above process for connecting power inlet 120 to a power source or breaker box.

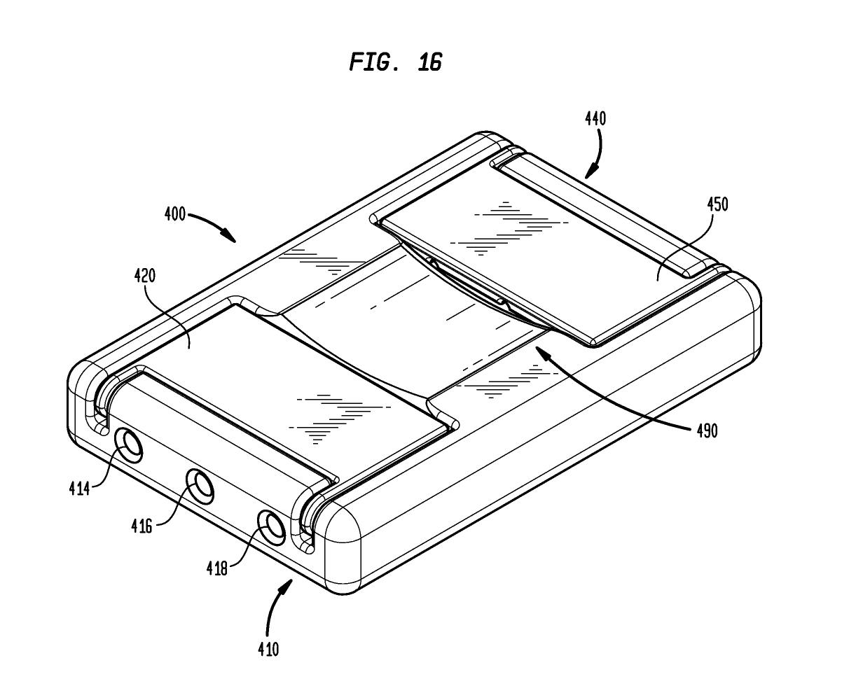

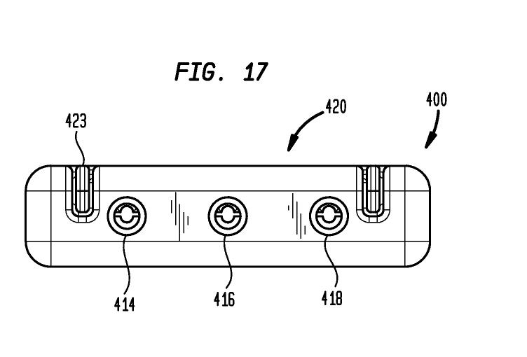

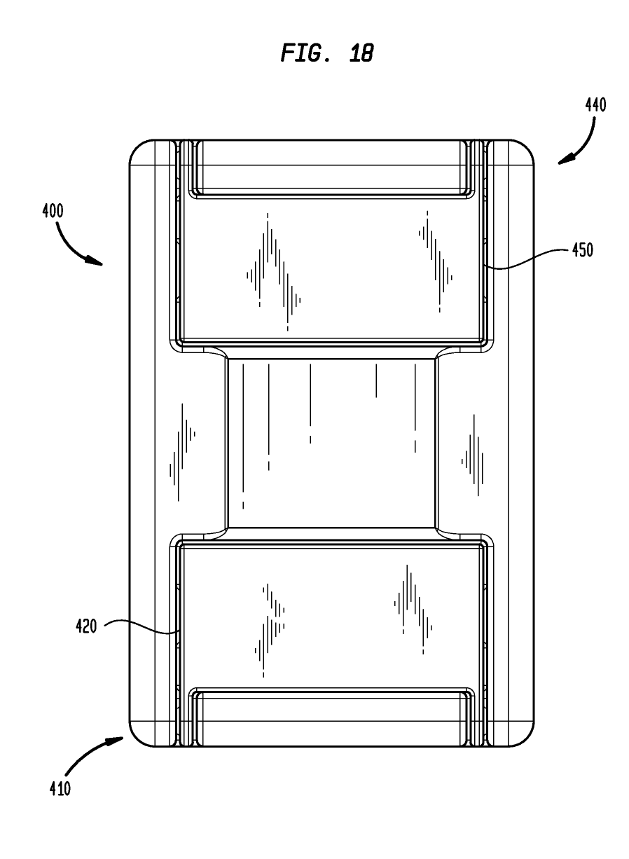

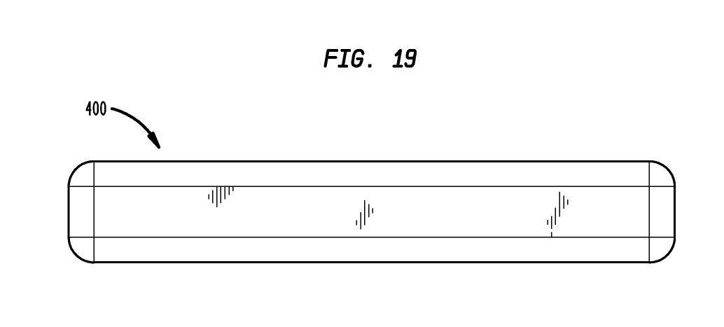

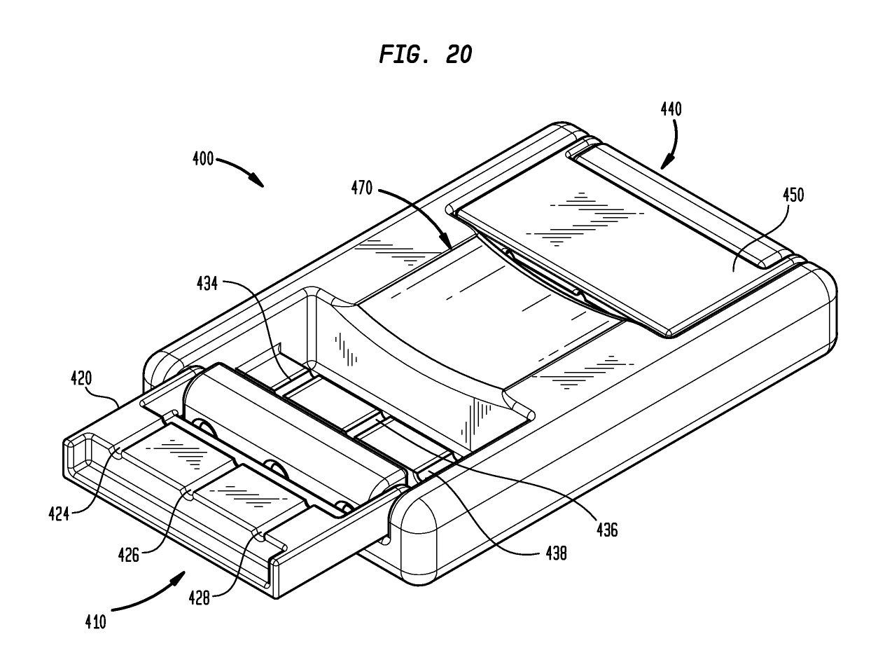

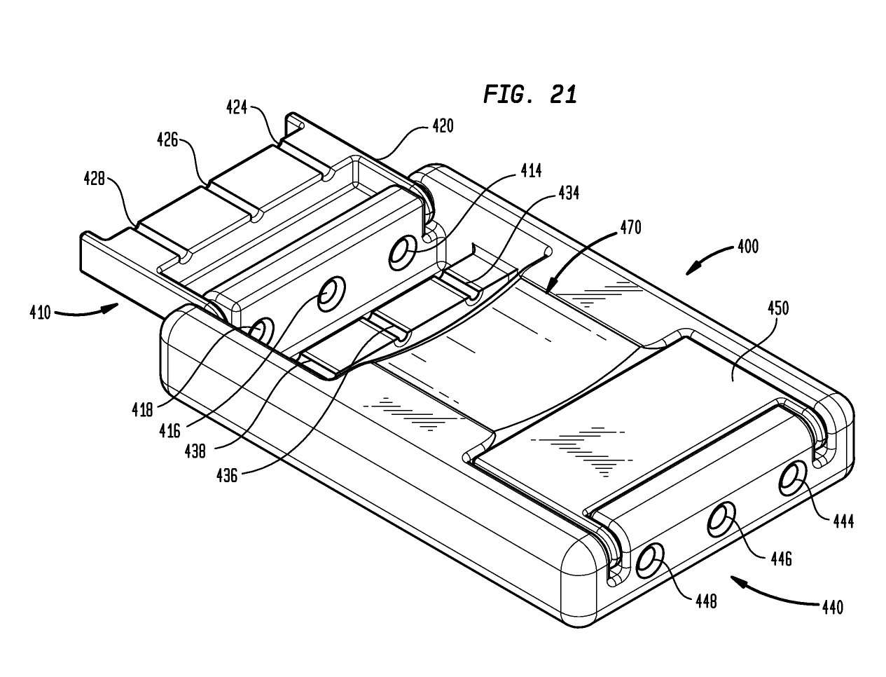

In an example, a joining or end connector may be provided for connecting between a power source wire and a plurality of light or ceiling fan wires using only one connector may be provided. FIG. 16 illustrates an isometric view of an example end connector. FIG. 17 illustrates a front view of the example end connector shown in FIG. 16. FIG. 18 illustrates a top view of the example end connector shown in FIG. 16. FIG. 19 illustrates a side view of the example end connector shown in FIG. 16. FIG. 20 illustrates a first isometric view of an example end connector shown in an open configuration. FIG. 21 illustrates a second isometric view of the example end connector shown in an open configuration.

Joining connector 400 is shown as it may be configured for operative coupling with distributor housing light circuit outlets 160 and/or 140 and includes at least one inlet 410 and at least outlet 440. An input enclosure is configured to selectively enable access to the at least one inlet 410 while at least one output enclosure is configured to selectively enable access to the at least one outlet 440. The input enclosure includes power 428 & 438, neutral 426 & 436 and ground 424 & 434 conduits operatively coupled between the inlet and at least one input port provided in central region 470.

The output enclosure is shown as it may include power 458 & 468, neutral 456 & 466 and ground 454 & 464 conduits operatively coupled between the outlet and at least one output port provided in central region 470. Input 420 and output 450 panels may include portions 424, 426 and 428 and portions 454, 456 and 458 of the conduits and are pivotable between a position covering or otherwise obscuring the conduits and a position exposing the conduits.

Before continuing, it is noted that the devices and components are not limited in any way to the examples shown. The devices and components may be manufactured according to any suitable method using any suitable materials.

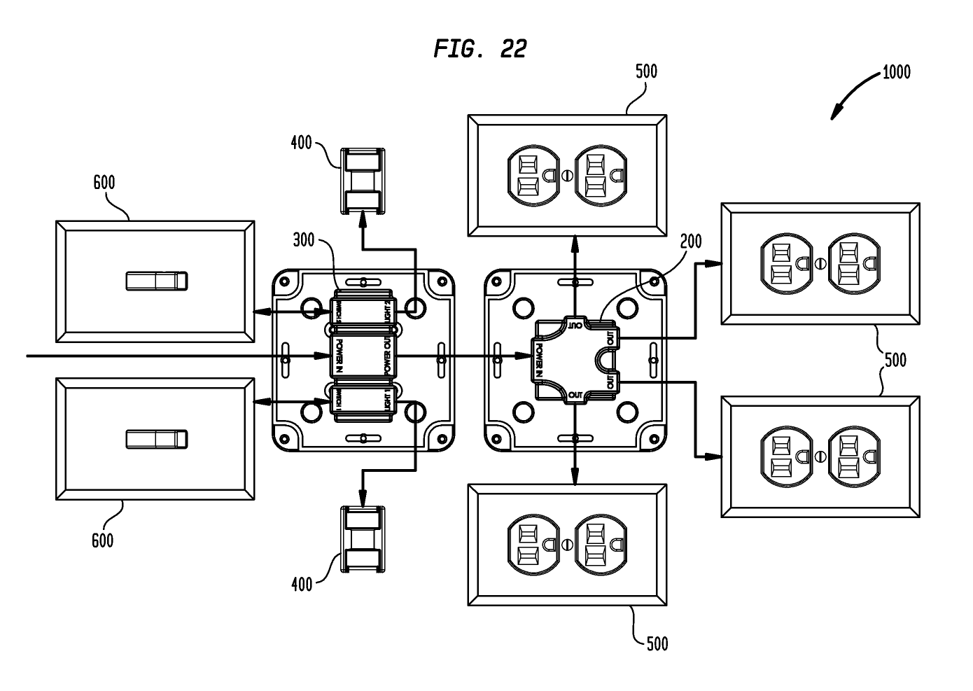

FIGS. 22 & 23 illustrate various aspects of an example mini electrical distribution system 1000 including an example electrical flow through individual components. In an example, a switch connector 300, which may be provided within a housing, is connected to a main power source or breaker box by a compound wire and receives control input from switches 600. Joining connectors 400 and splitter connector 200 are connected to light circuit outlets 340 and/or 360 and power outlet 350, respectively. Lights, ceiling fans and any other electrically powered items (e.g., which may otherwise be difficult to wire directly to the main power source) may be powered by light circuit outlets 340 and/or 360 through joining connectors 400. In an example, lights and/or ceiling fans (and/or other loads) may be directly wired to outlets 140 or 160 (e.g., instead of through connectors 400).

When assembled, splitter connector 200 divides power received from power outlet 350 of switch connector 300 into two or more signals for output to two or more power outlets 220, 230, 240 and/or 250 from which wall socket outlets 500 receive power. Splitter connector 200 may also be provided within a housing.

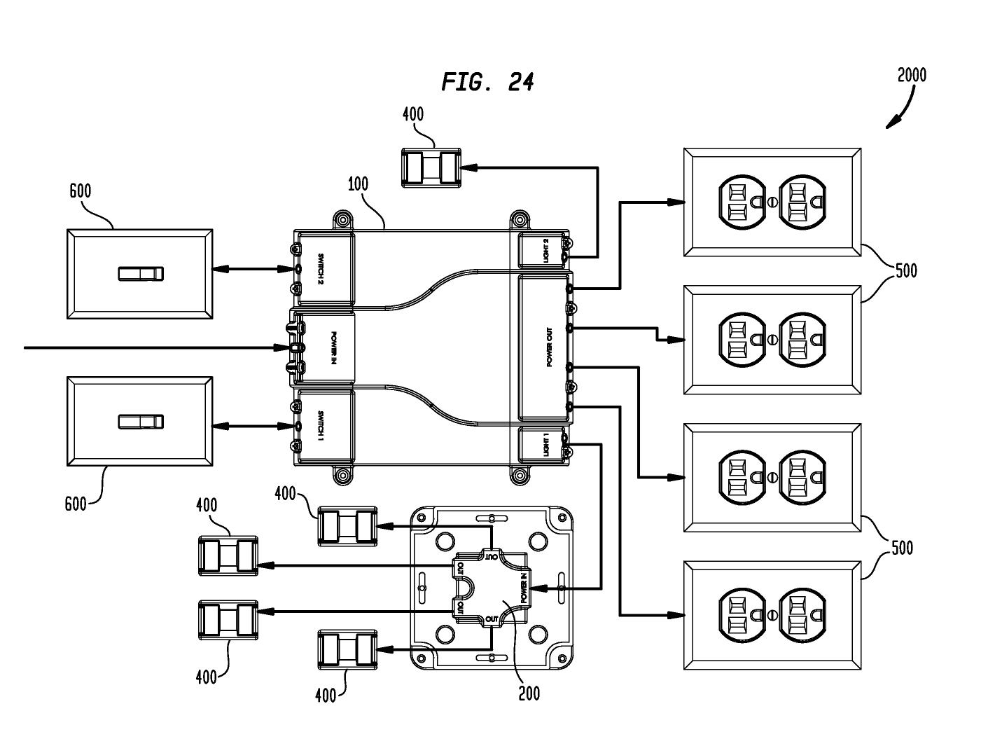

FIGS. 24 & 25 illustrate various aspects of an example main electrical distribution system 2000 including an example electrical flow through individual components. In an example, the switch connector 300 and a splitter 200 may be provided within distributor housing 100. As with the example mini electrical distribution system, switch connector 300, may be connected to a main power source or breaker box by a compound wire and may receive control input from switches 600. Light circuit outlets 340 and/or 360 may be connected to light circuit outlets 140 and/or 160. In turn, light circuit outlets 140 and/or 160 are connected to a splitter 200, and then further, to joining connectors 400 and lights or ceiling fans. Splitter 200 may be used to split a power line into two or more lines, for example for rooms with more than one light on the same switch. In some circumstances, light and ceiling fans may be directly wired to outlets 240 or 260 rather than through connectors 400.

A splitter connector 200 internal to distributor housing 100 may be connected to power outlet 350. Splitter connector 200 divides power received from power outlet 350 of switch connector 300 into two or more signals for output to two or more power outlets 230, 240 and/or 250 from which power outlets 152 receive power. Wall socket outlets 500 may be connected to power outlets 152.

In an example, one or more distribution units are provided, each configured to receive power from a main power supply or breaker box and distribute the power to at least one light circuit and/or wall outlets. One or more splitter connectors are also provided, each allowing one power source to be split into two or more power sources. One or more switch connectors are provided, configured to receive power from a main circuit or breaker box and selectively provide the power to one or more light circuits and/or wall outlets. One or more joining connectors are also provided, each allowing connection between a power source wire and a plurality of light or ceiling fan (or other load) wires using only one connector.

The operations shown and described herein are provided to illustrate example implementations. It is noted that the operations are not limited to the ordering shown. Still other operations may also be implemented. Further operations may include providing the one or more distribution units such that the one or more distribution units receive and protect an output end of a power wire as well as input ends of outlet and/or light circuit wires.

The above examples are provided for purposes of illustration. Still other examples are contemplated, as will become apparent to those having ordinary skill in the art after becoming familiar with the following detailed disclosure and corresponding figures.

1. A method of providing an electrical distribution kit, comprising:
providing a modular distribution unit with quick connects, the modular distribution unit connecting with other modules in the kit in a configuration to receive power from a main power supply, and distribute the power via one or more other the other modules to at least one load.

2. The method of claim 1, further comprising:
providing a modular splitter connector configured to cooperate with the modular distribution unit and split one power source into two or more power sources.

3. The method of claim 1, further comprising:
providing a modular joining connector to cooperate with the modular distribution unit and establish a connection between a power source wire and a plurality of load wires using only one connector.

4. The method of claim 1, further comprising:
providing a modular switch connector configured to cooperate with the modular distribution unit and receive power from a main circuit or breaker box and selectively provide the power to one or more light circuits or wall outlets.

5. The method of claim 1, wherein the distribution unit is configured to receive and protect both an output end of a power wire and input ends of outlet wires or light circuit wires.

6. A system for distributing electrical power from a main power supply or breaker box, comprising:
a distributor housing having at least one switch inlet, at least one power inlet, at least one light circuit, and at least one power outlet;
at least one splitter connector comprising at least one splitter power inlet, and at least two splitter power outlets operatively coupled with the at least one light circuit and the at least one power outlet;
at least one switch connector comprising at least one switch inlet operatively coupled with the at least one distributor housing switch inlet, at least one power inlet operatively coupled with the at least one distributor housing power inlet, at least one power outlet operatively coupled with the at least one splitter power inlet, and at least one light circuit operatively coupled with the distributor housing at least one light circuit; and
at least one joining connector configured to be operatively coupled with the distributor housing light circuit.

7. The system of claim 6, wherein the at least one splitter connector and the at least one switch connector are enclosed by a central enclosure of the distributor housing.

8. The system of claim 6, wherein the distributor housing includes at least one power inlet enclosure configured to selectively provide access by a user to the at least one power inlet.

9. The system of claim 8, wherein the at least one power inlet enclosure further comprises a pivotable panel.

10. The system of claim 6, wherein the distributor housing further comprises:
at least one switch inlet enclosure configured to selectively enable user access to the at least one power inlet;
at least one light circuit outlet enclosure configured to selectively enable user access to the at least one light circuit outlet; and
at least one power outlet enclosure configured to selectively enable user access to the at least one power outlet.

11. The system of claim 10, wherein the at least one power inlet enclosure, the at least one light circuit outlet enclosure and the at least one power outlet enclosure each comprise a pivotable panel.

12. The system of claim 6, wherein the at least one joining connector includes at least one inlet and at least outlet.

13. The system of claim 12, wherein the at least one joining connector includes at least one inlet enclosure configured to selectively enable user access to the at least one inlet.

14. The system of claim 12, wherein the at least one joining connector includes at least one outlet enclosure configured to selectively enable user access to the at least one outlet.

15. An electrical power distributor, comprising:
a distributor housing having at least one switch inlet, at least one power inlet, at least one light circuit outlet and at least one power outlet;
at least one splitter connector comprising at least one splitter power inlet and at least two splitter power outlets operatively coupled with the at least one light circuit outlet and the at least one power outlet; and
at least one switch connector comprising at least one switch inlet operatively coupled with the at least one distributor housing switch inlet , at least one power inlet operatively coupled with the at least one distributor housing power inlet, at least one power outlet operatively coupled with the at least one splitter power inlet and at least one light circuit outlet operatively coupled with the distributor housing light circuit outlet.

16. The distributor of claim 15, wherein the at least one splitter connector further comprises:
a ground plate configured to conduct electricity between a power input ground terminal and two or more power output ground terminals;
a neutral plate configured to conduct electricity between a power input neutral terminal and two or more power output neutral terminals; and
a power plate configured to conduct electricity between a power input power terminal and two or more power output power terminals.

17. The distributor of claim 16, wherein the at least one splitter connector further comprises at least one insulating region between the ground and neutral plates and one insulating region between the neutral and power plates.

18. The distributor of claim 15, wherein the at least one switch connector further comprises:
a ground plate configured to conduct electricity among the at least one switch inlet, the at least one switch connector power inlet, the at least one switch connector power outlet and the at least one switch connector light circuit outlet;
a first neutral plate configured to conduct electricity among the at least one switch connector power inlet, the at least one switch connector power outlet and the at least one switch connector light circuit outlet;
a second neutral plate configured to conduct electricity between the at least one switch connector inlet and a second power plate;
a first power plate configured to conduct electricity between the at least one switch connector power inlet and the at least one switch connector power outlet; and
a second power plate configured to conduct electricity among the at least one switch connector inlet, the at least one switch connector light circuit outlet, and the second neutral plate.

19. The distributor of claim 18, wherein the at least one switch connector further comprises a first insulating region between the ground plate and first neutral plate and a second insulating region between the first neutral plate and the first power plate.

20. The distributor of claim 18, further comprising:
a third power plate configured to conduct electricity between a switch connector inlet and a second switch connector light circuit outlet; and
a third neutral plate configured to conduct electricity between the at least one switch connector inlet and the third power plate.
